(19) United States
(12) Patent Application Publication
(10) Pub. No.: US 2003/0033166 A1
(43) Pub. Date: Feb. 13, 2003

(54) Systems and methods for dynamically pricing products

(75) Inventor: Stephan Scharmacher, Jemgum (DE)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Beehot GmbH, Jemgum (DE)

(21) Appl. No.: 10/215,204

(22) Filed: Aug. 9, 2002

Related U.S. Application Data
(60) Provisional application No. 60/311,124, filed on Aug. 10, 2001.
(60) Provisional application No. 60/318,907, filed on Sep. 14, 2001.

(51) Int. Cl. G06F 17/60

(52) U.S. Cl. 705/1

(57) ABSTRACT

The present invention provides systems and methods for pricing products with software that may be electronically networked to user and/or customer interfaces. The systems and methods of the present invention price products at levels proportional to customer interest in seeing the prices of those products. The software is capable of prompting customers to issue a nominal fee in order to view a current price for a product of interest. The software is also capable of recalculating the current price to be displayed to a customer based on the aggregate view-price fee amounts paid by the current customer and all non-purchasing customers who preceded him within the current sales cycle.

This application claims priority under 35 U.S.C. § 119(e) to U.S. patent application Ser. No. 60/311,124, filed Aug. 10, 2001; and to U.S. application Ser. No. 60/318,907, filed Sep. 14, 2001, both of which are incorporated herein by reference.

### FIELD OF THE INVENTION

The present invention disclosed herein relates to systems and methods for dynamically pricing products via an electronic network where the prices of the products are varied based on customer interest in them. More particularly, the present invention relates to a system and method for displaying the prices of products to customers who pay a fee to see the prices and then reducing the prices by some amount proportional to the amount of fees collected. The invention provides a unique method for pricing products in proportion to customer interest and for encouraging customers to buy products at prices that have been reduced because other customers chose not to purchase the products.

### BACKGROUND OF THE INVENTION

In today's electronic marketplace, many marketing strategies have been employed. Some of the most successful strategies have involved commerce with a dynamic character such that the pricing of products for sale via an electronic network depends on customer input. In several such dynamic commerce methods, customers interactively bid for products as part of Internet auctions. A consequence of many of these auctions is that the vendor is obligated to sell its product at the highest customer bid even if the price for which a vendor desires to sell its product is not be met by that bid. The vendor, in such cases, reluctantly must sell its product with a reduced margin. To remedy such reduced margin sales, some Internet auctions allow a vendor to set a reserve price, which the highest customer bid must meet or exceed in order for the vendor to be obligated to sell its product. A problem with reserve price auctions, though, is that in order to ensure no margin is lost for a product, the vendor may have to set the reserve price at a level that no bidders are willing to pay and, therefore, the product may go unsold.

Other electronic marketing strategies focus on portal web sites, such as Internet malls, where links to several vendor web sites are cataloged and displayed to customers from a single reference site. These Internet mall web sites, however, link customers to various other sites where the means of purchasing products may vary. Therefore, the mall web sites do not offer a uniform purchasing process by which a customer may visit one portal web site and purchase several different vendors' products by a uniform process.

### SUMMARY OF THE INVENTION

The present invention provides dynamic commerce systems and methods that allow customers to potentially buy products at very low prices via an interactive pricing system that does not reduce the vendor's margin for those products. The present invention provides a pricing system controlled by software that may be electronically networked to user and/or customer interfaces. The software is capable of prompting customers to issue a nominal fee in order to view a current price for a product of interest. The software is also capable of recalculating the current price to be displayed to a customer based on the aggregate fee amounts issued by the current customer and all non-purchasing customers who preceded him within the current sales cycle. Thus, the pricing system of the present invention dynamically sets the price of a product at a level proportional to the customer interest in seeing the product's price. Since the dynamic price is set based on a function of the fees collected from non-purchasing customers, both the purchasing customer and the vendor are benefited by the pricing system.

The pricing system of the present invention can be employed directly by product vendors, by third-parties on behalf of various vendors, or by application service providers (“ASPs”). When third-parties employ the system on behalf of other vendors, the third parties are capable of providing a purchasing process for customers of the various vendors that is both dynamic and uniform.

### BRIEF DESCRIPTION OF THE DRAWINGS

FIG. 1 shows a schematic diagram of a pricing system according to the present invention.

FIG. 2a shows a schematic diagram of one embodiment of an electronically networked pricing system according to the present invention.

FIG. 2b shows a schematic diagram of one embodiment of an electronically networked pricing system according to the present invention.

FIG. 2c shows a schematic diagram of one embodiment of an electronically networked pricing system according to the present invention.

FIG. 2d shows a schematic diagram of one embodiment of an electronically networked pricing system according to the present invention.

FIG. 3 shows a schematic diagram of part of a method for pricing products according to the present invention.

FIG. 4 shows a schematic diagram of an example of a sales cycle according to the present invention.

### DETAILED DESCRIPTION OF THE INVENTION

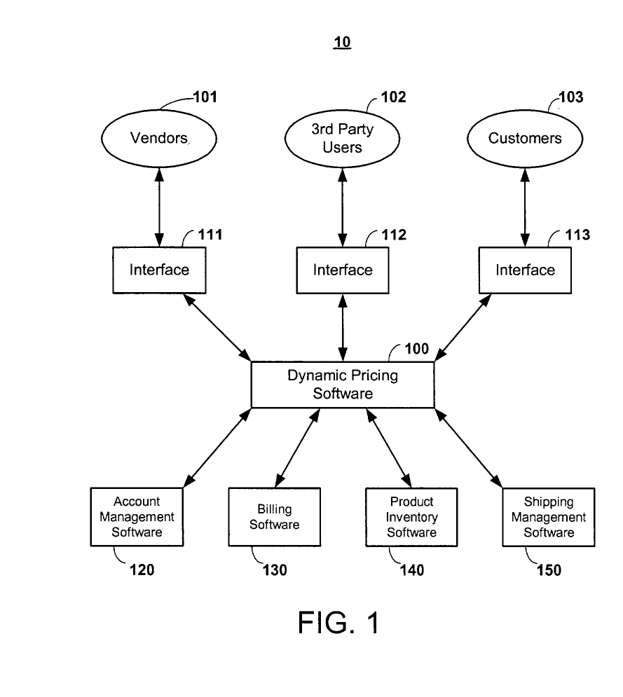

FIG. 1 shows a particular embodiment of a dynamic pricing system 10 of the present invention, in which software 100 is provided that controls the dynamic price management of products offered for sale with pricing system 10 and receives input from vendors 101, third party users 102, and customers 103 via certain interfaces 111, 112, and 113, such as web pages. The software 100 also controls the information displayed to those users and it formats the displays of interfaces 111, 112, and 113. Software 100 may also be in communication with account management software 120, billing software 130, product inventory software 140, and shipping management software 150.

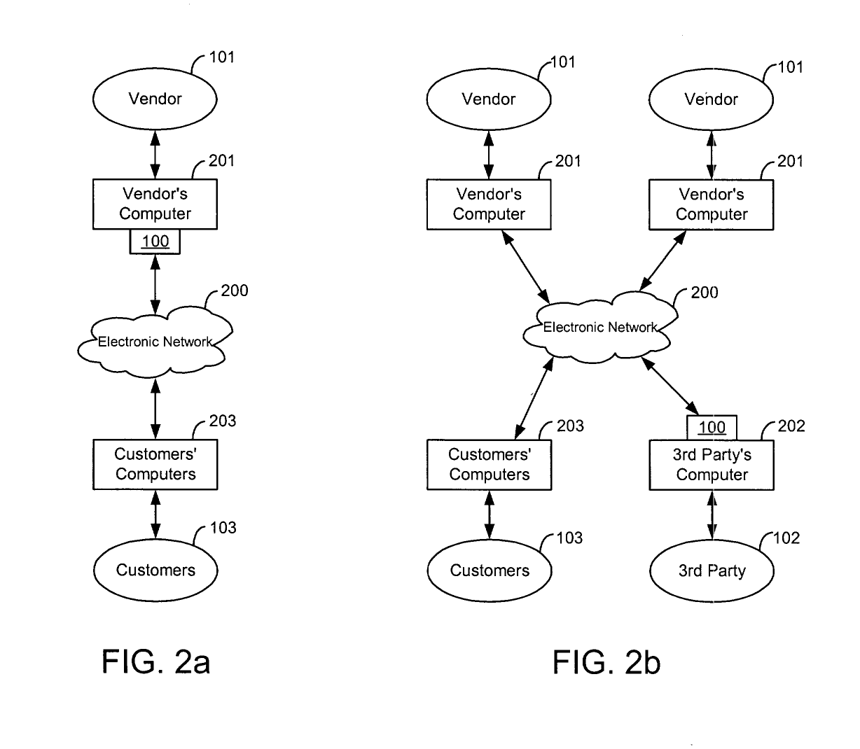

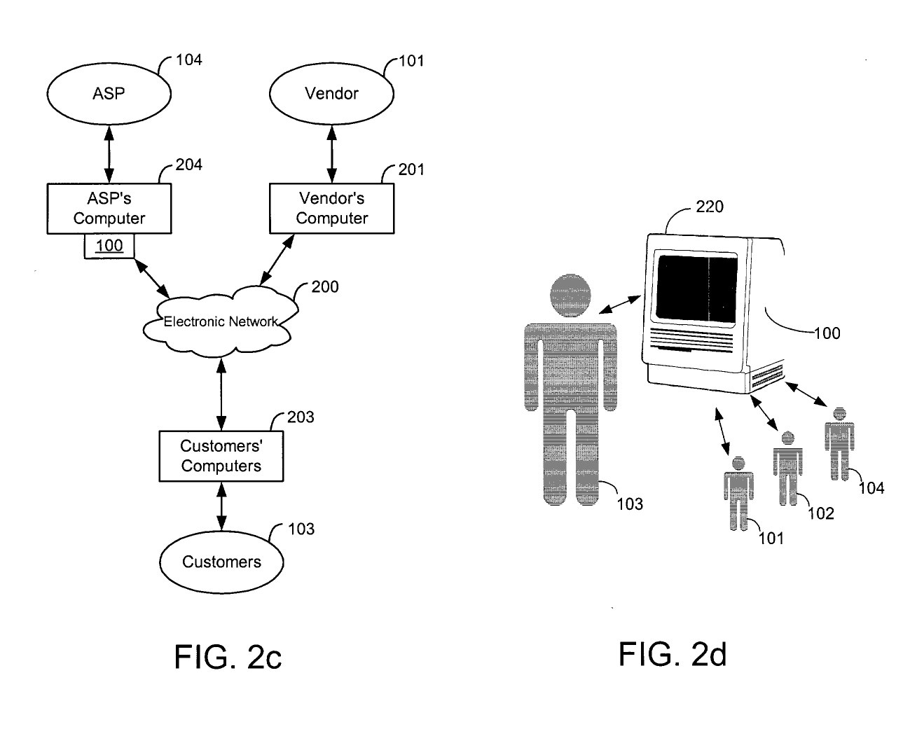

As shown in FIGS. 2a, 2b, and 2c, software 100 may be stored on and executed from a vendor's computer system 201 or from a third-party's computer system 202 via electronic network 200 in order to price products for purchase by customers 103 who access electronic network 200 with their own computer systems 203. FIG. 2a shows an embodiment of the present invention in which a vendor 101 may access the network and execute software 100 from its own computer system 201 in order to sell its own products. FIG. 2b shows an embodiment of the present invention in which a third-party 102 may use the system via electronic network 200 to sell products of various vendors, manufacturers, or distributors 101. FIG. 2c shows an embodiment of the present invention in which a third-party may act as an application service provider (“ASP”) 104 for products with software 100. As shown in FIG. 2d, software 100 may also be stored on and executed from an off-line computer system provided with a stand-alone terminal 220, where terminal 220 and/or software 100 are maintained by a vendor 101, third-party 102, or ASP 104.

When vendor 101 uses software 100 via electronic network 200 to dynamically price its own products, it may execute and maintain software 100 on its own computer system 201. Vendor 101 may also merely execute software 100 from its own computer system 202 and rely upon a third party 102 to maintain software 100 and fix any bugs. The vendor's commerce system interface 113 as presented to customers 103 may be designed to seam with the vendor's own commerce software interface such that the pricing system 10 of the present invention appears to customers 103 as part of the vendor's own commerce system.

Third-party 102 may operate a portal interface with electronic network 200 with which customers 103 may browse products offered for sale by different vendors 101. Third-party 102 may execute pricing software 100 for any or all of the products from the different vendors 101. A third-party portal interface may provide customers with a shopping and purchasing experience that is uniform even though various vendors' products may be offered for sale by the same third-party.

Referring to FIG. 2c, when a vendor 101 uses an ASP 104, the vendor's own commerce system may relay customer inputs and requests related to pricing system 10 of the present invention to the ASP's system. ASP 104 then returns information generated by pricing system 10 to the vendor's commerce system. For example, a customer 103 may view product information on a vendor's web site and when he clicks a link to access information from pricing system 10, ASP 104 serves the pricing information to the vendor's commerce system via electronic network 200. The vendor's commerce system then communicates the pricing information to customer 103 who is accessing the vendor's commerce system. The ASP's controlling interface to software 100 may be designed to seam with the vendor's own commerce system interface as presented to customers 103 such that the pricing system 10 of the present invention appears to customers 103 as part of the vendor's own commerce system.

In the above embodiments of the present invention wherein the provider of software 100 is not the same entity as the vendor of the products priced by system 10, the provider may charge the vendor a fee or commission for the use of pricing system 10. In a particular embodiment, this fee or commission is only charged to the vendor for completed sales of its products thereby providing further incentive to the vendor to use pricing system 10.

Physical terminals 220 employing or networked to pricing software 100 dynamic pricing system may be deployed in any of various retail or public locations. Networked terminals may provide a vendor 101 with access to potential customers where the customers do not have to take the initiative to gain access to network 200. For example, a department store could place terminals 220 among its physical products whereby in-store customers may conventionally shop the store's product line and then use a terminal to view a product's price that has been dynamically set by pricing system 10 of the present invention.

Alternatively, physical terminals 220 employing pricing software 100 may be stand-alone devices. These stand-alone devices may be totally independent, i.e., not networked to any other system, or they may be linked with a mere local network of inventory and billing systems and/or other like terminals. Independent stand-alone devices may be used to display actual products housed within the device in a manner similar to a vending machine. A customer who walks up to such a stand-alone device could view the current price of the displayed products as it is generated by the pricing software 100 stored on a computer within the terminal. Upon a completed purchase, these independent stand-alone terminals may dispense the actual product to the walk-up customer.

Stand-alone terminals may also merely display images or representations of products. In one embodiment of the present invention, images of those products of too great a value or of too large a size to reasonably be housed within an independent stand-alone terminal may be displayed from at least one terminal. Whether the terminal displaying images of product priced according to system 10 is independent or part of a local network, the delivery of a product purchased at a terminal displaying mere images of the product is arranged by means other than the immediate dispensing of the product from the terminal. For example, the vendor could retrieve the product from its on-site storage facilities or it could arrange for postal or other delivery of the product according to its normal method of delivering purchased products.

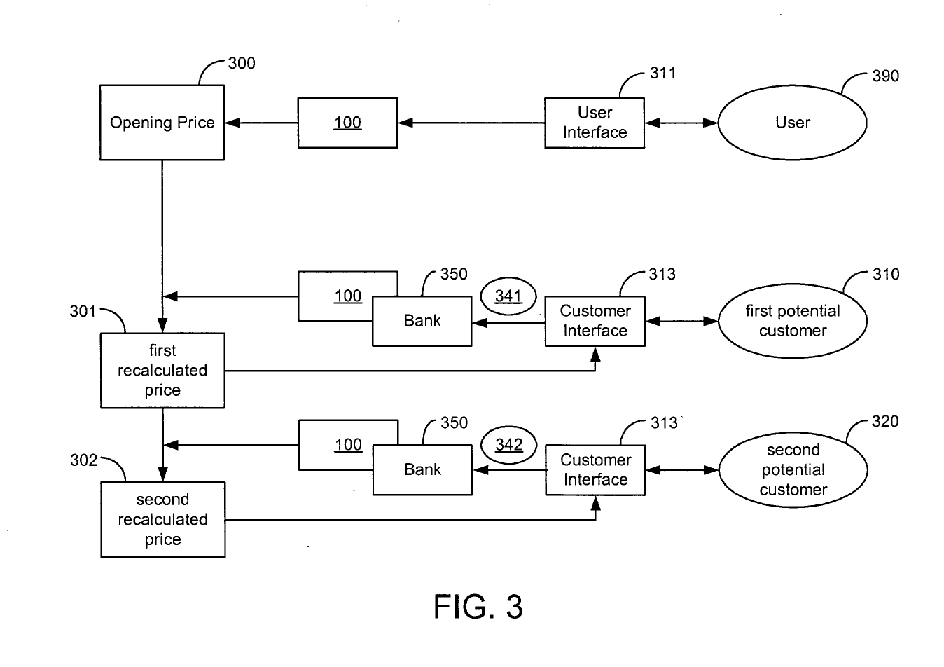

Referring now to FIG. 3, a user 390 (e.g., a seller, vendor, third party user, or ASP) selects a base or opening price 300 for each of its products before placing those products for sale with pricing system 10. User 390 inputs opening price 300 of a product into software 100 via user interface 311 and software 100 then assigns opening price 300 as the current price for the product as displayed by customer interface 313. Customer interface 313 with pricing system 10 may be a web site. It is also contemplated that pricing system 10 may be integrated with various other customer interfaces 313, such as a voice recognition platform or a physical terminal interface (as described above). Software 100 may dynamically reassign a new price as the current price displayed to a customer by customer interface 313 each time there is a change in the current price of the product. A change in the current price of a product occurs each time software 100 recalculates the price. Software 100 may recalculate the current price each time a customer pays a view-price fee 341 or 342 and deposits the fee into a bank 350 for the product.

For example, as shown in FIG. 3, a first potential customer 310 issues, via customer interface 313, a first view-price fee 341 which is deposited into bank 350. Software 100 may then reassign a first recalculated price 301 as the current price that is displayed to first potential customer 310 via customer interface 313. Should the first potential customer 310 not purchase the product at first recalculated price 301, a second potential customer 320 may then issue, via customer interface 313, a second view-price fee 342 which is deposited into bank 350. Software 100 may then reassign a second recalculated price 302 as the current price that is displayed to second potential customer 320 via customer interface 313.

During recalculation, software 100 reduces the current price of the product by a certain amount equal to or less than the amount of funds deposited into the product's bank 350. The reduction amount may be based upon the total amount of funds in the bank 350 for the product. For example, the reduction amount may be smaller the more funds are in the bank 350 so that the vendor's margin grows at an increasing rate per potential customer (wherein a potential customer is one who deposits a view price fee but has yet to purchase the product). Software 100 may also halt reduction but still allow deposits of view price fees after a certain amount of funds are in the bank 350 for a product.

Software 100 may continue to recalculate the current price for a product after each deposit of a view price fee made by a customer until upon such recalculation, a certain pre-defined nominal price, e.g., one dollar, or a pre-defined floor price (as set by user 390) is assigned by software 100 as the current price of the product.

Several embodiments of customer interface 313 may be used in accordance with the present invention. For example, a potential customer may first encounter a main product listing interface, be it a vendor's web site displaying its own products or a third party's web site displaying products of multiple vendors, where he may browse listings of products that are offered for sale. Current dynamic prices of the products for sale may be initially withheld from the customer's view, though a promotional price, such as a manufacturer's suggested retail price or the vendor's opening price 300 for the product may be displayed. An immediate purchase price, i.e. a price conventionally set by the vendor and not derived via pricing system 10, may also be displayed to the customer. The customer may browse written descriptions, pictures, and any other information about the products as supplied by their vendor. Any of such information may be displayed on the main interface, on a product description interface, or on both.

A product description interface may also include information for customers that explains how they may access the product's current dynamic price. For example, the product description interface may inform the customer that for the payment of a nominal fee, e.g., one dollar, the product's current dynamic price will be displayed. The customer may also be informed that the current dynamic price is constantly being lowered by the web site software, i.e., software 100, as other customers also pay the fee. The customer may be informed that each additional request for a product's price-view will require an additional fee payment, but that over time the price may drop well below the initial opening price of the product due to the aggregate fees collected from non-purchasing customers. The customer may be enticed by the explanation of the product-price-view process to return multiple times to the product-price-view web page in hopes of happening across a current price to his liking. The nominal fee may be varied by the user 390 or it may be varied automatically by software 100 to be some proportion to the current price of the product.

Upon deciding to view the current dynamic price of a product on its price-view interface, a potential customer may be prompted by software 100 to issue payment of a view-price fee via account management software 120 (FIG. 1) and/or electronic network 200 (FIGS. 2a-2c). Once he pays the fee, the customer is directed to the product-price-view interface. The customer may also provide his account information a single time to software 100 or to account management software 120 so that the view-price fee may be debited to his account automatically upon his subsequent requests to view products' current dynamic prices. Each automatic debit of the view-price fee may constitute an issuance of that fee. This single provision of account information by a customer may accompany the application for or initiation of a membership for that customer in a service which provides the use of the dynamic pricing system as a benefit of membership. Such a service may levy a fee for membership and may credit any or all of that fee towards future payments of view-price fees. In addition to electronically debiting a customer's account, embodiments of the system served to customers via a stand-alone terminal 220 (FIG. 2d) may also allow the deposit of hard currency for the payment of a view-price fee.

Prior to the customer being directed to the product-price-view interface but after his issuing payment of the view-price fee, software 100 dynamically recalculates the current price of the product. The customer is then directed to the product's price-view interface where the recalculated price is displayed as the current price.

Software 100 assigns or otherwise recognizes a bank 350 for each product into which customer view-price payments are deposited. Each time a customer issues payment of a view-price fee, that fee amount is added to the product's bank 350 by account management software 120 and/or software 100.

In one embodiment of the present invention, the view-price fee selected by user 390 is a nominal fee, e.g., one dollar. In an alternative embodiment, the view-price fee is generated by software 100. Software 100 may generate variable view-price fee amounts based on the frequency of customer requests for the particular product's current price or based upon the sales volume of the particular product. For example, if more than a pre-set number of customers have paid the view-price fee as of a pre-set point during a sales cycle of a particular product, software 100 may increase the view-price fee. If less than a pre-set number of customers have paid the view-price fee for a product as of a pre-set point in a sales cycle, then software 100 may reduce the view-price fee to an amount that more customers accept. The pre-set variables may be entered into software 100 by the user of the system via user interface 311 or they may be default values written into the software.

If a second request to view a product's price-view web page is made by second potential customer 320 after first potential customer 310 has issued price-view payment but before potential customer 320 has been directed to the product's price-view interface, potential customer 320 may be shown a first recalculated current price 301 based only upon the amount of money in the product's bank 350 deposited immediately before his request and the amount of his first view-price fee 341 payment. Second potential customer 320 may be shown second recalculated current price 302 based upon the amount of money in the product's bank 350 after both customers' payments. Each customer will, therefore, view prices based on his own request and those requests made prior to his request.

When a customer decides to purchase a product at the current price displayed to him by pricing system 10, he may initiate a purchasing transaction via software 100 and/or electronic network 200. Software 100 may communicate with account management software 120, billing software 130, product inventory software 140, and/or shipping management software 150 (FIG. 1) in order to automatically process the transaction or it may display the customer's transactional information to a user for manual processing of the product order.

Each sales cycle for a particular product terminates upon the completion of a purchasing transaction. It is during each sales cycle that software 100 calculates price reductions and reassigns the current price for the product. At the end of a sales cycle according to one embodiment of the system of the present invention, software 100 reassigns opening price 300 as the current price for the start of a new sales cycle. Alternatively, some price less than opening price 300 may be assigned as the current price to start a new sales cycle.

In one embodiment of pricing system 10, opening price 300 is never shown to any customers. The first customer to view the current price in a new sales cycle will be shown a current price equal to the opening price minus the amount of the view-price fee he paid or minus some amount less than that view price fee. Alternatively, opening price 300 may be displayed to all customers along with the other product information provided by user 390. In this alternative embodiment, an assurance may be made to the potential customers that the current price displayed to them will be some value less than opening price 300. User 390 of the present pricing system may also offer a product for immediate sale at the opening price for customers who are not interested in utilizing dynamic pricing system 10.

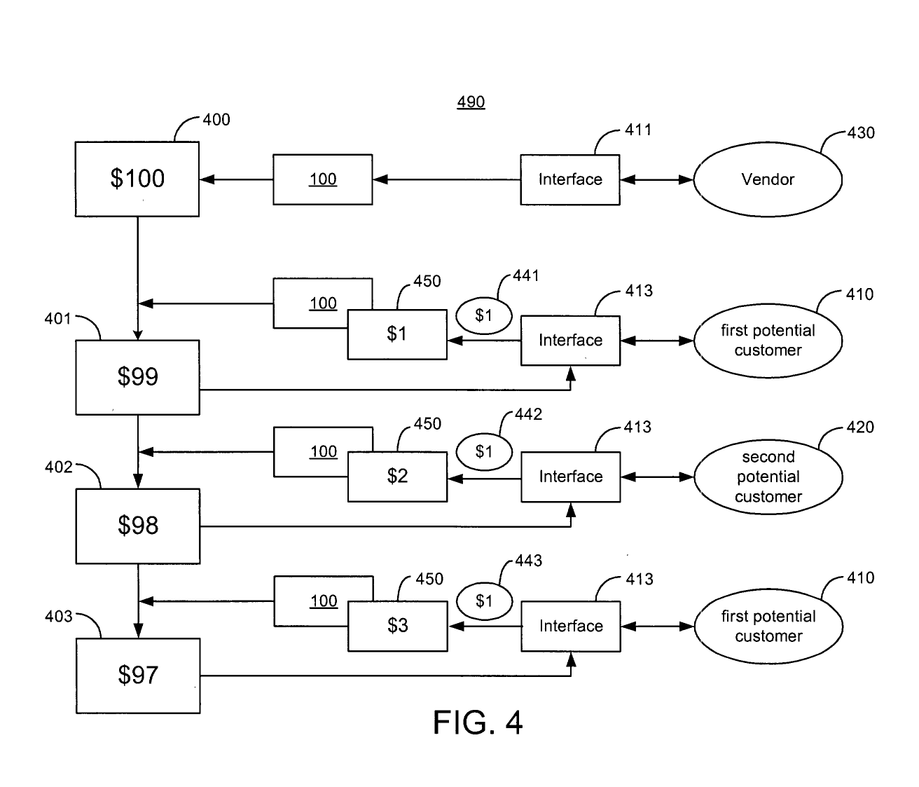

FIG. 4 shows a simplified example of a single sales cycle 490 according to the dynamic pricing system of the present invention. In this example, first potential customer 410 requests to view the current price of a product whose vendor 430 had selected an opening price 400 of $100 via user interface 413. First potential customer 410 pays a first view-price fee 441 of $1, which is added to the product's bank 450, via user interface 413. Bank 450 then represents $1 and software 100 reassigns first recalculated price 401 as the current price based on the amount in the bank 450 and displays it as $99 to first potential customer 410 via user interface 413. First potential customer 410 chooses not to buy the product at first recalculated price 401. Second potential customer 420 then requests the current price of the same product and pays second view-price fee 442 of $1, which is added to bank 450, via user interface 413. Bank 450 then represents $2 and software 100 reassigns second recalculated price 402 as the current price based on the amount in the bank 450 and displays it as $98 to second potential customer 420 via user interface 413. Second potential customer 420 chooses not to buy the product at second recalculated price 402. The first potential customer then requests the current price for a second time and pays third view-price fee 443 (his second fee) of $1, which is added to the product's bank 450, via user interface 413. Bank 450 then represents $3 and software 100 reassigns third recalculated price 403 as the current price based on the amount in the bank 450 and displays it as $97 to first potential customer 410 via user interface 413. This time, first potential customer 410 chooses to buy the product at third recalculated price 403. Sales cycle 490 is completed upon the election of first potential customer 410 to buy the product at the current price of $97 and software 100 then resets the current price to opening price 400 as $100 for a subsequent sales cycle of an identical product in the vendor's inventory.

FIG. 4 shows the relative benefits of pricing system to each of first and second potential customers and the product's vendor. First potential customer 410 benefited by electing to buy the product after a second potential customer requested to view the current price. The benefit to first potential customer 410 was equal to the amount of fees collected from the non-purchasing customers (in this example: $1 from second potential customer 420).

As long as at least one non-purchasing customer issues a view-price fee for a product before a purchasing customer views the current price, then the purchasing customer will benefit from pricing system 10 because he will be purchasing the product for a price (including the sum of all of his view-price fee payments) that is less than that of the opening price of the product. Had 50 customers viewed the current price and elected not to purchase (instead of just one as in the example shown in FIG. 4) between each of the requests of first potential customer 410 to view the current price, first potential customer 410 would have been shown a current price of $48 upon his second request and thus would have benefited even more from dynamic pricing system 10.

Further benefits, as shown in the example in FIG. 4, are to the product's vendor who gained both exposure of its products to multiple potential customers and the sale of its product without a reduced margin. Second potential customer 420 benefited in sales cycle 490 by way of only being out a nominal fee of $1 for viewing the current price of the product.

I claim:

1. A method for pricing a product comprising the steps of:
calculating a first price of the product;
collecting a view-price fee from a potential customer;
reducing the first price of the product to a second price, wherein the difference in price between the first price and the second price is less than or equal to the view-price fee; and
displaying the second price of the product to the potential customer upon collection of the view-price fee.

2. The method for pricing a product according to claim 1, wherein said step of calculating the first price of the product comprises the steps of:
setting an opening price for the product; and
reducing the opening price to said first price based on the aggregate amount of view-price fees collected prior to the collection of the view-price fee from the potential customer and during a current sales cycle.

3. The method for pricing a product according to claim 1, wherein said method is implemented over an electronic network.

4. The method for pricing a product according to claim 1, wherein said method is implemented in a stand-alone terminal.

5. The method for pricing a product according to claim 1, wherein said method is implemented by a vendor of the product.

6. The method for pricing a product according to claim 1, wherein said method is implemented by a first entity so as to price a product for a second entity.

7. The method for pricing a product according to claim 6, wherein said first entity is an application service provider.

8. The method for pricing a product according to claim 6, wherein said first entity charges a commission and/or a fee to the second party for operating the software.

9. The method for pricing a product according to claim 1, wherein said view-price fee is provided as a membership benefit to the potential customer.

10. A system for pricing products comprising:
a first price calculator which sets a first price of the product;
a view-price fee collector which accepts a view-price fee deposit from a potential customer;
a second price calculator which reduces the first price set by the first price calculator to a second price, wherein the difference between the first price and the second price is less than or equal to the view-price fee deposited by the potential customer into the view-price fee collector; and
an interface which shows the second price set by the second price calculator of the product to the potential customer after deposit of the view-price fee by the potential customer into the view-price fee collector.

11. The system for pricing products according to claim 10, wherein said system is a stand-alone terminal.

12. The system for pricing products according to claim 10, wherein said system is connected to an electronic network.

13. A system for pricing products comprising:
a means for calculating a first price of the product;
a means for collecting a view-price fee from a potential customer;
a means for reducing the first price of the product to a second price, wherein the difference in price between the first price and the second price is less than or equal to the view-price fee; and
a means for displaying the second price of the product to the potential customer upon collection of the view-price fee.

14. The system for pricing products according to claim 13, wherein said system is a stand-alone terminal.

15. The system for pricing products according to claim 13, wherein said system is connected to an electronic network.

16. A program storage device readable by a machine, tangibly embodying a program of instructions executable by a machine to perform method steps of pricing a product, the method steps comprising:
calculating a first price of the product;
collecting a view-price fee from a potential customer;
reducing the first price of the product to a second price, wherein the difference in price between the first price and the second price is less than or equal to the view-price fee; and
displaying the second price of the product to the potential customer upon collection of the view-price fee.

17. The system for pricing products according to claim 16, wherein said system is a stand-alone terminal.

18. The system for pricing products according to claim 16, wherein said system is connected to an electronic network.
